(19) United States
(12) Patent Application Publication
(10) Pub. No.: US 2014/0211396 A1
(43) Pub. Date: Jul. 31, 2014

(54) ELECTRONIC APPARATUS

(71) Applicant: Kabushiki Kaisha Toshiba, Tokyo (JP)

(72) Inventor: Toshikazu Shiroishi, Hamura-shi (JP)

(73) Assignee: Kabushiki Kaisha Toshiba, Tokyo (JP)

(21) Appl. No.: 14/030,795

(22) Filed: Sep. 18, 2013

Related U.S. Application Data
(63) Continuation of application No. PCT/JP2013/058397, filed on Mar. 22, 2013.

(30) Foreign Application Priority Data
Jan. 29, 2013 (JP) 2013-014145

(51) Int. Cl. G06F 1/16

(52) U.S. Cl. CPC G06F 1/1671
USPC 361/679.18

(57) ABSTRACT

According to one embodiment, an electronic apparatus includes a housing, a click pad, and a supporter. The click pad includes a first end configured to be bent toward an inside of the housing to push a switch, and a second end opposite the first end. The first supporter is configured to support the click pad from the inside of the housing as a supporting point of bending of the click pad when the first end of the click pad is pushed. The first supporter is movable along a direction from the second end to the first end of the click pad.

### CROSS REFERENCE TO RELATED APPLICATIONS

This application is a Continuation Application of PCT Application No. PCT/JP2013/058397, filed Mar. 22, 2013 and based upon and claiming the benefit of priority from Japanese Patent Application No. 2013-014145, filed Jan. 29, 2013, the entire contents of all of which are incorporated herein by reference.

### FIELD

Embodiments described herein relate generally to electronic apparatuses.

### BACKGROUND

An image display input device comprising an elevating and lowering mechanism has been proposed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an electronic apparatus according to a first embodiment.

FIG. 2 is an exemplary perspective exploded view illustrating a click pad unit according to the first embodiment.

FIG. 3 is an exemplary perspective view illustrating a structure in which a click pad, holder, a receiver and a click feeling adjustment member according to the first embodiment are assembled.

FIG. 4 is an exemplary perspective view illustrating a structure in which the holder, the receiver and the click feeling adjustment member according to the first embodiment are assembled.

FIG. 5 is an exemplary perspective view illustrating a structure in which the receiver and the click feeling adjustment member according to the first embodiment are assembled.

FIG. 6 is an exemplary sectional view taken along the line F6-F6 of the electronic apparatus illustrated in FIG. 1.

FIG. 7 is an exemplary sectional view taken along the line F7-F7 of the electronic apparatus illustrated in FIG. 1.

FIG. 8 is an exemplary expanded sectional view illustrating an area surrounded by the line F8 illustrated in FIG. 7.

FIG. 9 is an exemplary perspective view illustrating a structure in which a receiver and a click feeling adjustment member according to a second embodiment are assembled.

FIG. 10 is an exemplary sectional view of a click pad unit according to the second embodiment.

FIG. 11 is an exemplary perspective view illustrating a receiver and a supporter according to a third embodiment.

### DETAILED DESCRIPTION

Various embodiments will be described hereinafter with reference to the accompanying drawings.

In general, according to one embodiment, an electronic apparatus comprises a housing, a click pad, and a supporter. The click pad comprises a first end configured to be bent toward an inside of the housing to push a switch, and a second end opposite the first end. The first supporter is configured to support the click pad from the inside of the housing as a supporting point of bending of the click pad when the first end of the click pad is pushed. The first supporter is movable along a direction from the second end to the first end of the click pad.

In this specification, some components are expressed by two or more terms. Those terms are just examples. Those components may be further expressed by another or other terms. And the other components which are not expressed by two or more terms may be expressed by another or other terms.

Various embodiments are described hereinafter with reference to the accompanying drawings.

### First Embodiment

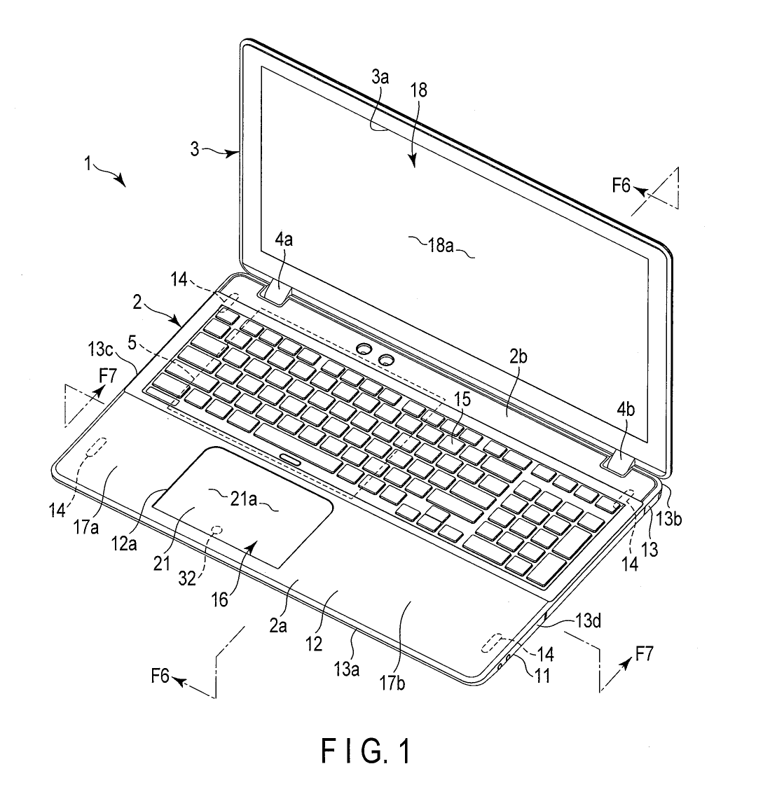

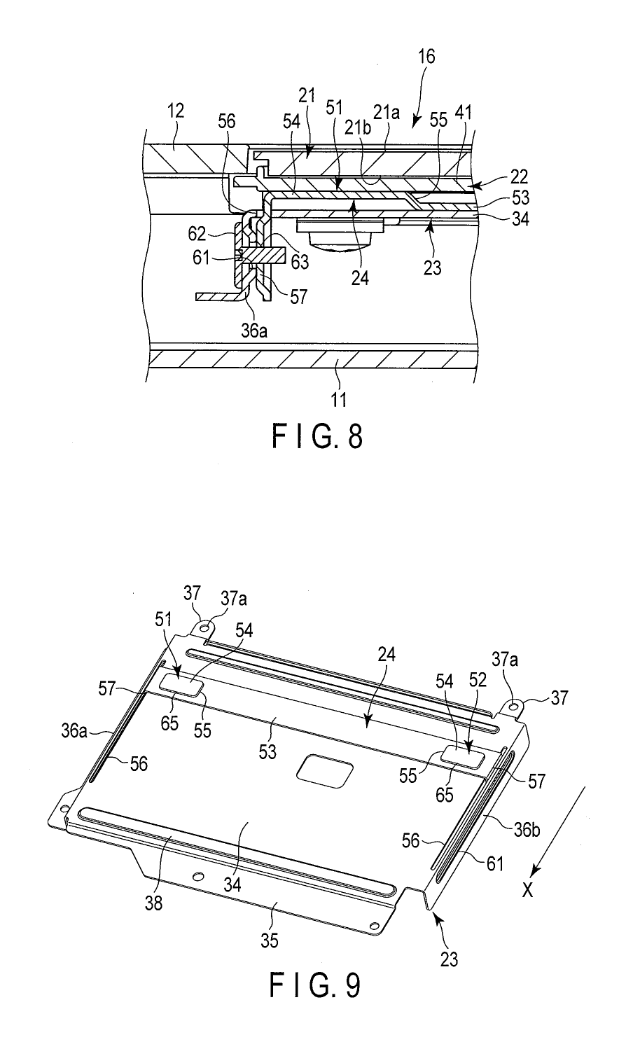

An electronic apparatus 1 according to a first embodiment is described with reference to FIGS. 1 to 8. As illustrated in FIG. 1, the electronic apparatus 1 according to this embodiment is, for example, a notebook personal computer (a notebook PC). It should be noted that the electronic apparatus to which this embodiment can be applied is not limited to the above example, and can be broadly applied to various types of electronic apparatuses such as a tablet terminal, a television, a cellular phone (including a smart phone) and a game console.

As illustrated in FIG. 1, the electronic apparatus 1 comprises a first housing 2, a second housing 3 and hinges 4a and 4b. The first housing 2 is, e.g., a main body housing. For example, a circuit board 5 and a battery are contained in the first housing 2.

The first housing 2 comprises a lower wall 11 (i.e., a bottom wall or a first wall), an upper wall 12 (i.e., a second wall) and a peripheral wall 13 (i.e., a third wall), and is formed in the shape of a flat box. The lower wall 11 is opposite to a desktop surface (i.e., a placement surface or an external placement surface), e.g., when the electronic apparatus 1 is placed on a desk. The lower wall 11 comprises, e.g., a plurality of leg portions 14 (i.e., supporting portions). The leg portions 14 are in contact with the desktop surface to support the electronic apparatus 1, when the electronic apparatus 1 is placed on the desk.

The upper wall 12 is located opposite to the lower wall 11. The upper wall 12 is substantially parallel to, e.g., the lower wall 11. For example, a keyboard 15 and a click pad unit 16 are provided on the upper wall 12. Each of the keyboard 15 and the click pad unit 16 is an example of “an input portion (i.e., an input reception portion).” It should be noted that the electronic apparatus 1 may comprise a touch panel (i.e., a touch sensor) or other input devices instead of the keyboard 15. An opening 12a from which the click pad unit 16 is exposed is provided on the upper wall 12.

The peripheral wall 13 is located in a direction crossing the lower wall 11 and the upper wall 12, and connects a peripheral portion of the lower wall 11 and that of the upper wall 12. The peripheral wall 13 comprises a front wall 13a, a back wall 13b, a first side wall 13c (e.g., a left wall) and a second side wall 13d (e.g., a right wall).

The first housing 2 comprises a first end 2a and a second end 2b. The first end 2a is, e.g., a front end. The second end 2b is located opposite to the first end 2a. The second end 2b is, e.g., a back end. The hinge 4a and 4b are connected to the second end 2b. It should be noted that in this specification, closer one from a user's viewpoint is defined as “front” and farther one is defined as “back” based on the position of the electronic apparatus put on the desktop surface. Also, right and left are defined from the user's viewpoint.

The front wall 13a is located at the first end 2a of the first housing 2, and extends in a longitudinal direction (i.e., a width direction) of the first housing 2. The back wall 13b is located opposite to the front wall 13a, and extends substantially in parallel with the front wall 13a. The first side wall 13c and the second side wall 13d extend in a direction crossing the front wall 13a and the back wall 13b (e.g., substantially perpendicularly), and connect the front wall 13a and the back wall 13b.

As illustrated in FIG. 1, the click pad unit 16 is located between the front wall 13a and the keyboard 15. The first housing 2 comprises palm rests 17a and 17b between the click pad unit 16 and the first side wall 13c, and between the click pad unit 16 and the second side wall 13d.

As illustrated in FIG. 1, the second housing 3 is, e.g., a display housing. A display 18 (i.e., a display device or a display module) is contained in the second housing 3. The display 18 comprises a display screen 18a. An opening 3a from which the display screen 18a is exposed is provided on the front wall of the second housing 3.

The hinges 4a and 4b rotatably (i.e., openably and closably) connect the end of the first housing 2 and that of the second housing 3. Thus, the electronic apparatus 1 is openable and closable (i.e., foldable). The electronic apparatus 1 is transformable between a first state in which the first housing 2 and the second housing 3 overlap each other, and a second state in which the first housing 2 and the second housing 3 are opened and the keyboard 15, the click pad unit 16 and the display screen 18a are exposed to the outside.

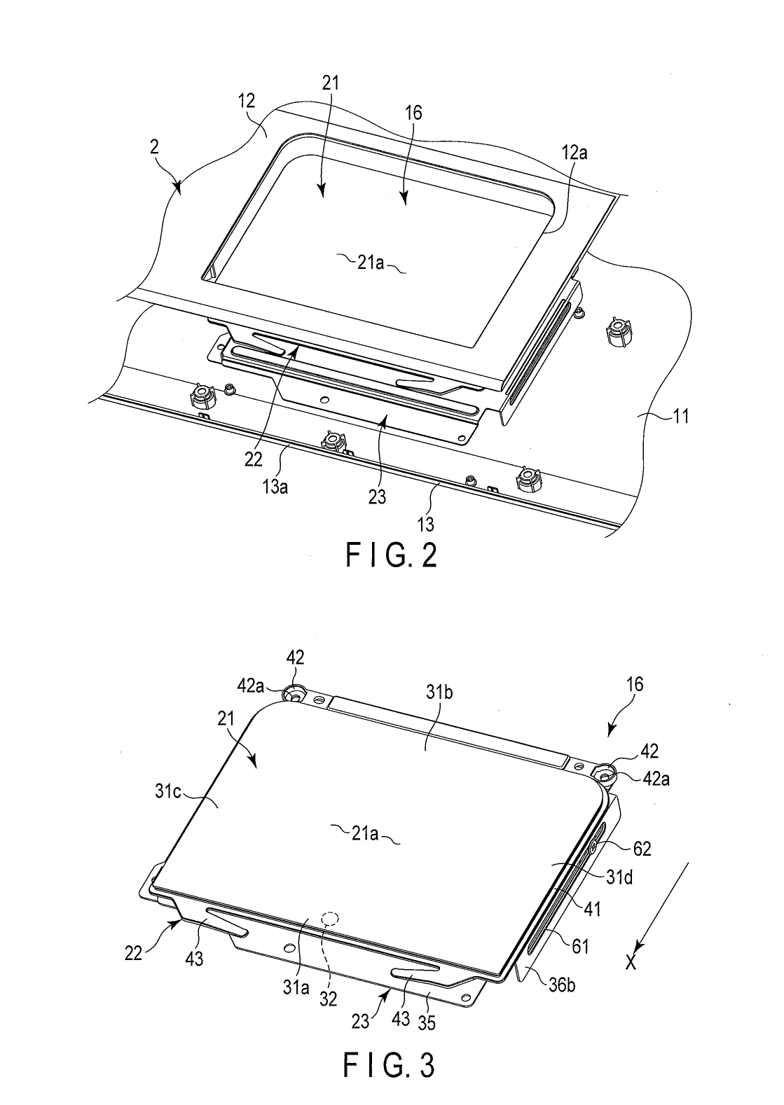

Next, the click pad unit 16 according to this embodiment is described in detail. It should be noted that the first housing 2 is hereinafter referred to as simply “housing 2.” As illustrated in FIGS. 2 to 5, the click pad unit 16 comprises a click pad 21, a holder 22, a receiver 23 and a click feeling adjustment member 24.

The click pad 21 is a flat-shaped input device comprising both of a function of a pointing device and a function of a push button. That is, the click pad 21 associates a movement of a finger tracing the surface of the click pad 21 (i.e., a locus) with the movement of a mouse pointer on the display screen 18a, and the movement of pushing the surface of the click pad 21 is treated as the same input operation as a click of a mouse.

More specifically, the click pad 21 comprises a first surface 21a (e.g., an operation surface or an input surface) and a second surface 21b (e.g., a rear surface or a supporting surface) located opposite to the first surface 21a. The first surface 21a is exposed to the outside of the housing 2 (i.e., the outside of the electronic apparatus 1). A user can operate the click pad 21 for input by tracing the first surface 21a, e.g., by a finger. On the other hand, the second surface 21b faces an inside of the housing 2.

As illustrated in FIG. 3, the click pad 21 comprises first to fourth ends 31a, 31b, 31c and 31d. The first end 31a is, e.g., a front end. The first end 31a extends substantially in parallel with the front wall 13a. The second end 31b is, e.g., a back end, and located opposite to the first end 31a. The second end 31b is located next to the keyboard 15. The second end 31b extends substantially in parallel with the first end 31a.

The third end 31c and the fourth end 31d extend in a direction crossing (e.g., substantially perpendicular to) the first end 31a and the second end 31b. The third end 31c and the fourth end 31d extend between the first end 31a and the second end 31b. The third end 31c is a first side end (e.g., a left end). The fourth end 31d is a second side end (e.g., a right end), and located opposite to the third end 31c.

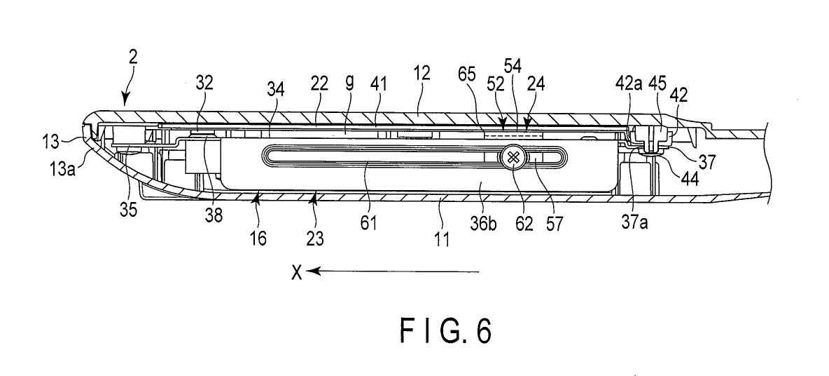

A switch 32 (e.g., a click switch or a push switch) is provided at the second surface 21b of the first end 31a of the click pad 21 (refer to FIGS. 3 and 6). The first end 31a of the click pad 21 is configured to be pushed toward the inside of the housing 2 to operate the switch 32. That is, the first end 31a of the click pad 21 is configured to be bent toward the inside of the housing 2 to push (i.e., operate) the switch 32. A user can input, e.g., determination or cancellation of a specific operation by actuating the switch 32.

Next, the receiver 23 (i.e., a receiving member or a receiving portion) is described first with reference to FIGS. 5 to 7. The receiver 23 is provided in the housing 2, and faces the second surface 21b of the click pad 21. The receiver 23 is, e.g., a sheet metal. The receiver 23 is located below the click pad 21, and receives the click pad 21 when the click pad 21 is pushed (i.e., sunk) toward the inside of the housing 2.

More specifically, as illustrated in FIG. 5, the receiver 23 comprises a first receiving portion 34, a second receiving portion 35, a pair of raised portions 36a and 36b and an attaching portion 37. The first receiving portion 34 (e.g., a first horizontal portion) comprises substantially the same outer shape as, e.g., the click pad 21. The first receiving portion 34 substantially horizontally extends to cover a lower portion of the click pad 21.

As illustrated in FIGS. 5 and 6, a projection 38 is provided in a front end of the first receiving portion 34. The projection 38 projects toward the switch 32 of the click pad 21, and faces the switch 32. The projection 38 may be in contact with the switch 32 in a state where the click pad 21 is not pushed, or be apart from the switch 32 at slight intervals. When the first end 31a of the click pad 21 is pushed toward the inside of the housing 2, the switch 32 is pushed by the projection 38 and actuated.

It should be noted that the switch 32 may be provided on the receiver 23 or another location in the housing 2 instead of the second surface 21b of the click pad 21. In this case, a structure for pushing the switch 32 (e.g., the projection 38) may be provided, e.g., on the second surface 21b of the click pad 21. According to such a structure, the first end 31a of the click pad 21 is configured to be bent toward the inside of the housing 2, and the structure for pushing the switch 32 can be realized.

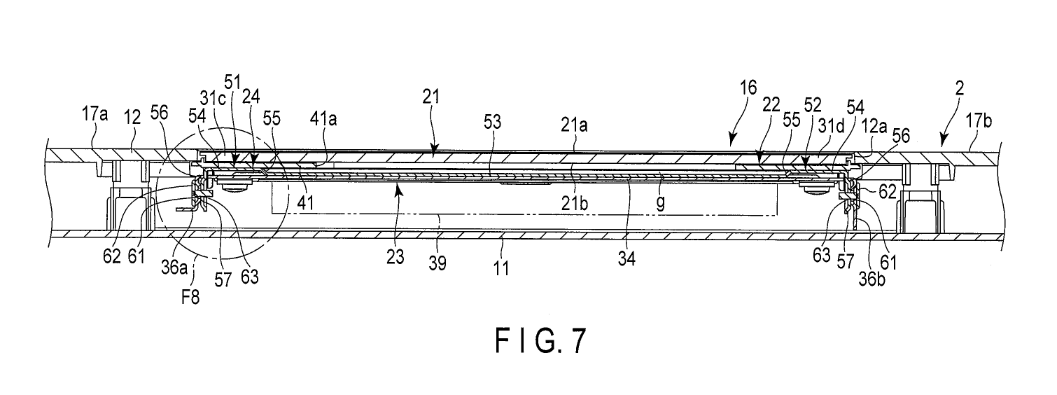

As illustrated in FIG. 7, a pair of raised portions 36a and 36b (i.e., a side wall) extend downward from right and left ends of the first receiving portion 34. For example, a module 39 is located between the pair of raised portions 36a and 36b. The module 39 is located between the first receiving portion 34 and the lower wall 11 of the housing 2. The module 39 is, e.g., a hard disk drive (HDD). That is, the receiver 23 according to this embodiment is also a member for HDD protection.

It should be noted that the module 39 which is covered by the receiver 23 is not limited to the HDD, and may be, e.g., a solid state drive (SSD), various substrates, a battery, an optical disk drive (ODD) or other parts. Alternatively, the receiver 23 may be a member provided for a purpose other than the purpose for protecting the module 39.

As illustrated in FIG. 5, the second receiving portion 35 (e.g., a second horizontal portion) projects forwards from the first receiving portion 34. The second receiving portion 35 substantially horizontally extends as well as the first receiving portion 34. On the other hand, the attaching portions 37 (i.e., fixed portion or supporting portion) are provided at a back end of the receiver 23. The attaching portion 37 projects to the rear of, e.g., the first receiving portion 34. The attaching portion 37 substantially horizontally extends as well as the first receiving portion 34. As illustrated in FIGS. 5 and 6, a hole 37a through which a screw 44 is configured to be inserted is provided in an attaching portion 37.

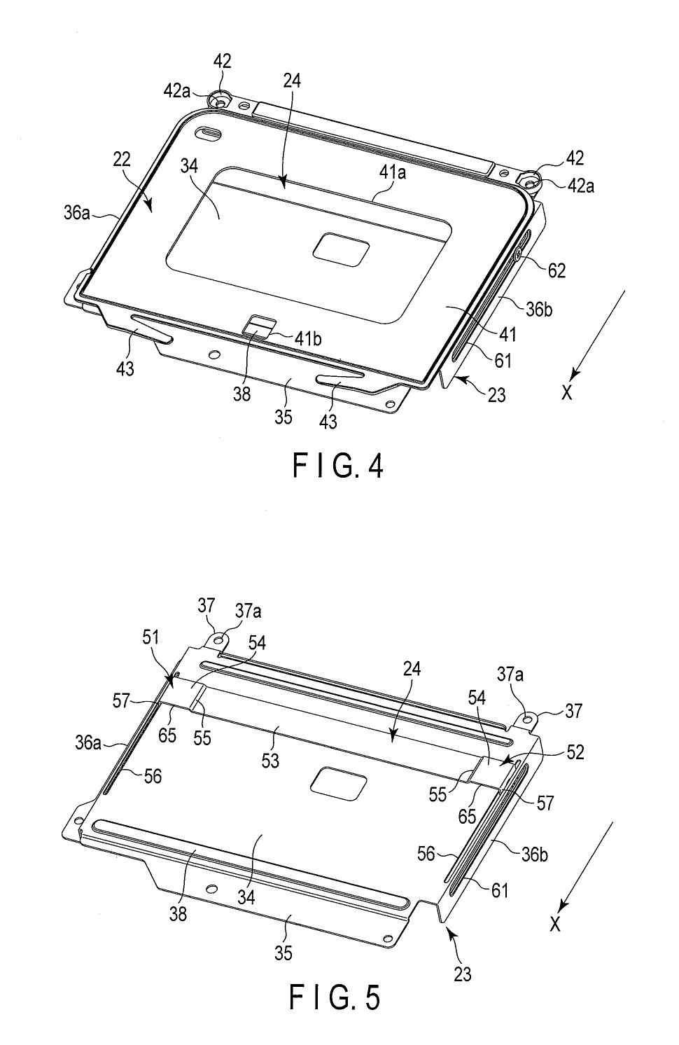

Next, the holder 22 is described with reference to FIGS. 4 to 7. As illustrated in FIGS. 4 and 7, the holder 22 (e.g., a click pad holder) configured to hold the click pad 21 is provided below the click pad 21. The holder 22 is located between the click pad 21 and the receiver 23. The holder 22 is provided in the housing 2, and supports the second surface 21b of the click pad 21.

More specifically, the holder 22 comprises a holding portion 41, an attaching portion 42 and an elastic supporting portion 43. The holding portion 41 comprises an outer shape larger than that of the click pad 21, and substantially horizontally extends to cover the lower portion of the click pad 21. A recess to which the click pad 21 is attached is provided on the upper surface of the holding portion 41. The click pad 21 is attached to the holding portion 41 by, e.g., a double-faced tape, and supported from the lower side.

It should be noted that regarding the holding portion 41 according to this embodiment, an opening 41a (i.e., a first opening) is provided, e.g., in the central portion of the holding portion 41, as illustrated in FIG. 4. By providing the opening 41a, an interference between a component and the holder 22 can be avoided when the component is provided on the second surface 21b of the click pad 21. The opening 41a may not be provided in the holding portion 41.

The holder 22 is made of, e.g., synthetic resin (e.g., rubber), and has elasticity. The holding portion 41 can bend toward the inside of the housing 2 along with the click pad 21 when the first end 31a of the click pad 21 is pushed. That is, the holding portion 41 and the click pad 21 can bend in accordance with the movement of the click pad 21 in an integrated manner. An opening 41b (i.e., a second opening) through which the switch 32 is inserted is provided in the holding portion 41. The switch 32 is put through the opening 41b, exposed in the housing 2 and faces the projection 38 of the receiver 23.

As illustrated in FIG. 4, the attaching portion 42 (i.e., a fixed portion or a supporting portion) is provided in, e.g., the back end of the holder 22. The attaching portion 42 comprises a portion projecting toward, e.g., the attaching portion 37 of the receiver 23. As illustrated in FIG. 6, the attaching portion 42 is in contact with the attaching portion 37 of the receiver 23, and supported by the receiver 23. Then, the holder 22 is supported in the housing 2. Also, the attaching portion 42 is supported by the receiver 23, and then a gap g in which the click pad 21 and the holding portion 41 can bend is kept between the holding portion 41 and the receiver 23.

As illustrated in FIGS. 4 and 6, a hole 42a through which the screw 44 is inserted is provided in the attaching portion 42. A fixed portion 45 (e.g., a boss) comprising a screw hole is provided at the inner surface of the upper wall 12 of the housing 2. The attaching portion 42 of the holder 22 and the attaching portion 37 of the receiver 23 are attached to the fixed portion 45 by the screw 44 (i.e., a fixture). According to this, the back end of the holder 22 is attached to the housing 2. The holder 22 can bend at the back end as a supporting point (i.e., a supporting point of rotation) in a state where the click feeling adjustment member 24 to be described is not provided.

On the other hand, the elastic supporting portion 43 is provided in, e.g., the front end of the holder 22. The elastic supporting portion 43 extends, e.g., in the shape of an arm. The elastic supporting portion 43 tapers toward, e.g., its distal end, and winds obliquely downward. According to this, the elastic supporting portion 43 can be transformed to a relatively large degree, and have sufficient elasticity.

The distal end of the elastic supporting portion 43 faces the second receiving portion 35 of the receiver 23. The distal end of the elastic supporting portion 43 may be in contact with the second receiving portion 35 in a state where the click pad 21 is not pushed, or be apart from the second receiving portion 35 at slight intervals. The first end 31a of the click pad 21 is pushed, and the click pad 21 and the holding portion 41 bend toward the inside of the housing 2. Then, the elastic supporting portion 43 relatively strongly comes into contact with the second receiving portion 35 of the receiver 23, and elastic deformation is performed. According to this, when a user's finger is separated from the click pad 21, the click pad 21 and the holding portion 41 are returned to an original location by elastic force of the elastic supporting portion 43 and the holding portion 41.

Next, the click feeling adjustment member 24 is described.

As illustrated in FIG. 5, the click feeling adjustment member 24 is detachably attached to the receiver 23 as necessary. The click feeling adjustment member 24 according to this embodiment is formed by, e.g., folding a slender sheet metal. The click feeling adjustment member 24 comprises first and second supporters 51 and 52 (i.e., supporting portion) and a connecting portion 53.

The first and second supporters 51 and 52 are provided by folding part of the click feeling adjustment member 24 toward the second surface 21b of the click pad 21 (e.g., upward). The first and second supporters 51 and 52 are separately located on the third end 31c and the fourth end 31d of the click pad 21.

Each of the first and second supporters 51 and 52 comprises a supporting point portion 54 (e.g., a contact portion or a plane surface portion) which receives the lower surface of the holder 22 (e.g., with which the holder 22 is in contact) when the first end 31a of the click pad 21 is pushed. The supporting point portion 54 is located in the upper portion of the first receiving portion 34 of the receiver 23. According to this, the supporting point portion 54 is located in the lower portion of the click pad 21, and faces the second surface 21b of the click pad 21.

The supporting point portion 54 may be in contact with the lower surface of the holding portion 41 in a state where the click pad 21 is not pushed, or be apart from the holding portion 41 at slight intervals. On the other hand, when the first end 31a of the click pad 21 is pushed and the click pad 21 is bent toward the inside of the housing 2, the supporting point portion 54 supports the second surface 21b of the click pad 21 from the inside of the housing 2, as a supporting point (i.e., a supporting point of rotation) of bending of the click pad 21.

More specifically, when the first end 31a of the click pad 21 is pushed, the supporting point portion 54 supports the second surface 21b of the click pad 21 via the holding portion 41. Thus, a portion in contact with the supporting point portion 54 of the click pad 21 is not substantially bent. The click pad 21 bends in an area which is in front of the first and second supporters 51 and 52 at an edge 65 (e.g., an anterior edge) of the supporting point portion 54 as a starting point of sinking.

As illustrated in FIG. 5, the connecting portion 53 is provided between the supporting point portions 54 of the first and second supporters 51 and 52. According to this, the first and second supporters 51 and 52 are connected to each other by the connecting portion 53. The connecting portion 53 comprises a step portion 55 between the supporting point portions 54 of the first and second supporters 51 and 52. The step portion 55 stands in a thickness direction of the click feeling adjustment member 24 (i.e., in a bending direction of the click pad 21). Stiffness of the thickness direction of the click feeling adjustment member 24 is improved by providing the step portion 55. According to this, the first and second supporters 51 and 52 can support the second surface 21b of the click pad 21 further stably.

As illustrated in FIG. 5, a pair of first holes 56 (e.g., slits) are provided in the first receiving portion 34 of the receiver 23. The first holes 56 extend in a direction X from the second end 31b to the first end 31a of the click pad 21. The pair of first holes 56 are separately located in the right and left ends of the first receiving portion 34 of the receiver 23. The length of the first holes 56 is more than half of the distance between, e.g., the first end 31a and the second end 31b of the click pad 21.

Each of the first and second supporters 51 and 52 comprises a guide 57. The guide 57 extends downward from the end of the supporting point portion 54, and is inserted into the first holes 56. The guide 57 is guided by the first holes 56 and movable. According to this, the click feeling adjustment member 24 (i.e., the first and second supporters 51 and 52) is slidable along the direction X from the second end 31b to the first end 31a of the click pad 21, and the location is changeable in the direction X. That is, the click feeling adjustment member 24 is slidable in a direction of approaching the first end 31a and going away therefrom.

As illustrated in FIGS. 6 and 7, a second hole 61 (e.g., a slit) is provided in each of the raised portions 36a and 36b of the receiver 23. The second hole 61 extends in the direction X from the second end 31b to the first end 31a of the click pad 21. The second hole 61 faces the guide 57 of the first and second supporters 51 and 52 of the click feeling adjustment member 24. The second hole 61 is an insertion hole through which a screw 62 is inserted.

A fixed portion 63 is provided in the guide 57. The fixed portion 63 is, e.g., a screw hole with which the screw 62 is engaged. That is, the first and second supporters 51 and 52 are attached to the receiver 23 by engaging the screw 62 put through the second hole 61 with the fixed portion 63. According to this, the first and second supporters 51 and 52 are attached to the receiver 23 and become motionless after the locations of the first and second supporters 51 and 52 are adjusted.

Next, an operation of the electronic apparatus 1 is described.

In this embodiment, the click feeling adjustment member 24 movable along the direction X from the second end 31b to the first end 31a of the click pad 21 is provided. When the first end 31a of the click pad 21 is pushed, the click pad 21 is bent at the edge 65 (the anterior edge) of the first and second supporters 51 and 52 of the click feeling adjustment member 24 as a starting point.

Thus, an amount of bending of the click pad 21 can be reduced and click feeling can be hardened by moving the click feeling adjustment member 24 toward the first end 31a of the click pad 21. On the other hand, the amount of bending of the click pad 21 can be increased and the click feeling can be softened by moving the click feeling adjustment member 24 toward the second end 31b of the click pad 21. Also, the click feeling adjustment member 24 can be omitted in a model (i.e., a type) which does not require high quality. According to this, costs can be easily reduced in the model which does not require the high quality.

In recent years, electronic apparatuses with the click pad are proposed. Since the click pad 21 also comprises the function of the pointing device, its size is relatively large. Thus, the amount of bending may be easy to widely vary in individual products under the influence of part tolerance, and the click feeling may be easy to vary. This makes the improvement of the quality of the electronic apparatus difficult.

On the other hand, the quality can be improved in the electronic apparatus 1 according to this embodiment. That is, the electronic apparatus 1 according to this embodiment comprises the housing 2, the click pad 21 and the first supporter 51. The click pad 21 comprises the first end 31a configured to be bent toward the inside of the housing 2 to push the switch 32, and the second end 31b opposite the first end 31a. The first supporter 51 is configured to support the click pad 21 from the inside of the housing 2 as the supporting point of the bending of the click pad 21, when the first end 31a of the click pad 21 is pushed. Also, the first supporter 51 is movable along the direction X from the second end 31b to the first end 31a of the click pad 21.

According to this structure, the location of the first supporter 51 can be adjusted along the direction X from the second end 31b to the first end 31a of the click pad 21, and the amount of bending of the click pad 21 can be easily adjusted. According to this, the click feeling can be easily adjusted for each product, e.g., when the click feeling widely varies. According to this, the quality of the electronic apparatus 1 can be improved.

The gap g between the click pad 21 and the receiver 23 is space for the bending of the click pad 21, and easy to be dead space. In this embodiment, such dead space is utilized and the click feeling adjustment member 24 is provided. That is, according to this embodiment, even though the click feeling adjustment member 24 is provided, upsizing of the electronic apparatus 1 can be avoided.

Also, in the model which does not require the high quality, e.g., the click feeling adjustment member 24 may be omitted. In other words, a model requiring the high quality and the model which does not require the high quality are switchable merely based on whether the click feeling adjustment member 24 is present or not, and no change of design of other portions is necessary. This contributes to cost reduction of the electronic apparatus 1.

In this embodiment, the click pad 21 comprises the first surface 21a exposed to the outside of the housing 2 and the second surface 21b opposite the first surface 21a. The first supporter 51 supports the second surface 21b of the click pad 21, when the first end 31a of the click pad 21 is pushed. According to this structure, the first supporter 51 supports the second surface 21b having a relatively large size of the click pad 21, and thus can support the click pad 21 further stably.

In this embodiment, the electronic apparatus 1 is provided in the housing 2, and further comprises the receiver 23 facing the second surface 21b of the click pad 21. The first supporter 51 is detachably attached to the receiver 23. According to this structure, the first supporter 51 is stably supported by the receiver 23. Thus, the click pad 21 can be further stably supported.

In this embodiment, the first supporter 51 is slidable along the direction X from the second end 31b to the first end 31a of the click pad 21. In this structure, the first supporter 51 is easy to make fine adjustments of the location. According to this, the quality of the electronic apparatus 1 can be further improved.

In this embodiment, a hole 56 extending in the direction X from the second end 31b to the first end 31a of the click pad 21 is provided in the receiver 23. The first supporter 51 comprises the guide 57 inserted into the hole 56. According to this structure, the first supporter 51 is movable along the hole 56, and the location can be easily adjusted.

In this embodiment, the first supporter 51 comprises the fixed portion 63 attached to the receiver 23 after the location of the first supporter 51 is adjusted. According to this structure, the location of the first supporter 51 is easy to be stable. According to this, the click pad 21 can be further stably supported.

For example, the click feeling is relatively hard to vary in the central portion of the click pad 21. On the other hand, the click feeling of the end of the click pad 21 is easy to vary in comparison with the central portion, e.g., under the influence of torsion of the click pad 21.

On the other hand, the electronic apparatus 1 according to this embodiment further comprises a second supporter 52 having substantially the same operation as the first supporter 51. The first supporter 51 and the second supporter 52 are separately located in the third end 31c and the fourth end 31d of the click pad 21. According to this structure, the click feeling of the end of the click pad 21 can be easily stably adjusted.

In this embodiment, the first supporter 51 and the second supporter 52 are connected to each other. According to this structure, the location of the first supporter 51 and that of the second supporter 52 can be simultaneously adjusted. Thus, the click feeling can be easily adjusted.

### Second Embodiment

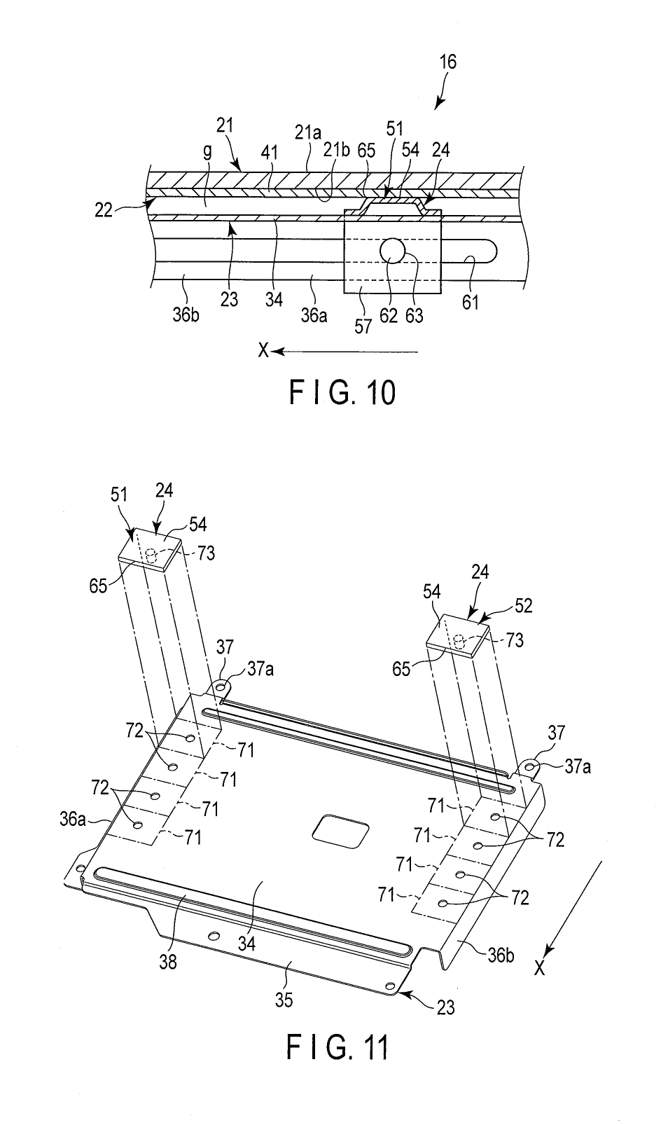

Next, an electronic apparatus 1 according to a second embodiment is described with reference to FIGS. 9 and 10. It should be noted that components comprising the same or similar functions as those in the first embodiment are denoted by the same reference numerals and a description thereof will not be repeated. In addition, structures other than the following structures are the same as those in the first embodiment.

As illustrated in FIGS. 9 and 10, first and second supporters 51 and 52 according to this embodiment are protrusions provided in a click feeling adjustment member 24. Such protrusions are formed by performing drawing on, e.g., part of the click feeling adjustment member 24.

According to such a structure, the quality of the electronic apparatus 1 can be improved as well as in the first embodiment.

### Third Embodiment

Next, an electronic apparatus 1 according to a third embodiment is described with reference to FIG. 11. It should be noted that components comprising the same or similar functions as those in the first embodiment are denoted by the same reference numerals and a description thereof will not be repeated. In addition, structures other than the following structures are the same as those in the first embodiment.

As illustrated in FIG. 11, a plurality of attachment locations 71 (i.e., fixed locations, attachment areas or attaching portions) are predetermined in a receiver 23 according to this embodiment along the direction X from the second end 31b to the first end 31a of the click pad 21. A fixed portion 72 (i.e., a first engaging portion) to which the first supporter 51 or the second supporter 52 is detachably attached is provided in each of the attachment locations 71. The fixed portion 72 is, e.g., a hole.

On the other hand, the first and second supporters 51 and 52 can be attached to an attachment location selected from the plurality of attachment locations 71. The first and second supporters 51 and 52 comprise an engaging portion 73 (i.e., a second engaging portion). The engaging portion 73 is a projection engaging with, e.g., the fixed portion 72. It should be noted that the fixed portion 72 may be a projection and the engaging portion 73 may be a hole, instead of the above structure.

According to such a structure, the quality of the electronic apparatus 1 can be improved as well as in the first embodiment. That is, click feeling of the click pad 21 can be easily adjusted by changing the locations of the first and second supporters 51 and 52. In other words, the click feeling can be hardened by shifting the locations of the first and second supporters 51 and 52 to a forward attachment location 71. Also, the click feeling can be softened by shifting the locations of the first and second supporters 51 and 52 to a backward attachment location 71.

It should be noted that a plurality of first supporters 51 and a plurality of second supporters 52 may be prepared and the click feeling may be adjusted by attaching the first and second supporters 51 and 52 to at least two attachment locations 71 of the plurality of attachment locations 71 as a variant example.

The above-described embodiments are not limited. In the implementation stage, the structural elements may be modified without departing from the scope. Various modifications can be realized by appropriately combining the structural elements disclosed in the embodiments. For instance, some of the disclosed structural elements may be deleted. Some structural elements of different embodiments may be combined appropriately.

For example, the size or shape of the holder 22, the receiver 23 or the click feeling adjustment member 24 is not limited to the above example. For example, the first and second supporters 51 and 52 may not be connected to each other, and they may be separately adjusted. Further, the number of supporter 51 may be one; and likewise, that of supporter 52.

The guide 57 of the first and second supporters 51 and 52 need not be located within the raised portions 36a and 36b of the receiver 23, i.e., it may be located outside of the raised portions 36a and 36b of the receiver 23. That is, the receiver 23 may be inserted between guides 57 of the first and second supporters 51 and 52. The structure of guiding the receiver 23 is not limited to the hole 56 or the guide 57, i.e., various structures can be properly adopted. Each of the first and second supporters 51 and 52 needs not be attached to the receiver 23, i.e., it may be attached to the housing 2 or other portions contained in the housing 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing;
a click pad comprising a first end configured to be bent toward an inside of the housing to push a switch, and a second end opposite the first end; and
a first supporter configured to support the click pad from the inside of the housing as a supporting point of bending of the click pad when the first end of the click pad is pushed, the first supporter being movable along a direction from the second end to the first end of the click pad.

2. The electronic apparatus of claim 1, wherein
the click pad comprises a first surface exposed to an outside of the housing and a second surface opposite the first surface, and
the first supporter is configured to support the second surface when the first end of the click pad is pushed.

3. The electronic apparatus of claim 2, further comprising:
a receiver in the housing, the receiver facing the second surface of the click pad,
wherein the first supporter is detachably attached to the receiver.

4. The electronic apparatus of claim 3, wherein
the first supporter is slidable along the direction from the second end to the first end of the click pad.

5. The electronic apparatus of claim 4, wherein
the receiver comprises a hole extending in the direction from the second end to the first end of the click pad, and
the first supporter comprises a guide inserted into the hole.

6. The electronic apparatus of claim 5, wherein
the first supporter comprises a fixed portion configured to be fixed to the receiver after a location of the first supporter is adjusted.

7. The electronic apparatus of claim 1, further comprising:
a second supporter configured to support the click pad from the inside of the housing as another supporting point of the bending of the click pad when the first end of the click pad is pushed, the second supporter being movable in the direction substantially identical to that of the first supporter,
wherein the click pad comprises a third end extending between the first end and the second end, and a fourth end opposite the third end, and
wherein the first supporter and the second supporter are separately in the third end and the fourth end of the click pad.

8. The electronic apparatus of claim 7, wherein
the first supporter and the second supporter are connected to each other.

9. The electronic apparatus of claim 1, wherein
the first supporter is configured to be attached to one location selected from a plurality of predetermined locations arranged in the direction from the second end to the first end of the click pad.

10. The electronic apparatus of claim 9, further comprising:
a receiver facing the click pad in the housing,
wherein the receiver comprises a fixed portion at each of the plurality of locations, to which the first supporter is configured to be detachably attached.
